(19) United States
(12) Patent Application Publication
(10) Pub. No.: US 2012/0021225 A1
(43) Pub. Date: Jan. 26, 2012

(54) LAMINATED COMPOSITIONS AND METHODS

(76) Inventors: Maki Maekawa, Kawasaki-shi (JP); Takahisa Kusuura, Kawasaki-shi (JP)

(21) Appl. No.: 13/123,643

(22) PCT Filed: May 14, 2010
(86) PCT No.: PCT/JP10/58579

§ 371 Date: Apr. 11, 2011

(51) Int. Cl. B32B 27/08; B32B 15/04; B32B 19/00; C09J 123/12; C09J 123/06; C09J 123/20; C09J 131/04; C09J 153/00; C09J 177/06; C09J 167/02; C09J 133/12; C09J 175/16; C09J 153/02; C09J 11/04; C09J 9/00; B32B 38/10; B32B 9/04

(52) U.S. Cl. 428/412; 428/411.1; 428/457; 428/688; 428/423.1; 428/423.3; 428/423.7; 428/483; 428/515; 524/582; 524/585; 524/579; 524/563; 524/524; 524/528; 524/606; 524/605; 524/562; 524/590; 521/139; 521/92; 521/91; 524/440; 524/507; 524/513; 524/514; 524/523; 524/403; 524/420; 524/402; 524/408; 156/712

(57) ABSTRACT

A laminated composition includes a first polymer layer having a first surface and a second surface; a second polymer layer having a first surface and a second surface; and an adhesive layer joining the second surface of the first polymer layer to a first surface of the second polymer layer; where the adhesive layer includes a heat-shrinkable resin including heat-generating particles.

### TECHNOLOGY

The technology generally related to the re-cycling and/or re-using of plastic waste, and to laminated plastics that are amenable to re-cycling or re-using.

### BACKGROUND

Laminated plastic, which is produced by laminating different types of resins to one another, is used in a wide range of applications. Waste laminated plastic film, which contains different types of resins with different properties, has typically been incinerated or buried in landfills for many years because of difficulties in separating the various plastic, i.e. polymer components, of the resins. For example, in many laminated plastics, the individual layers of the laminate do not mix well with one another even when heated, thus limiting their availability to be recycled.

Japanese Patent Application (Kokai) No. 2008-307896 discloses a laminated film having a polyester-based resin as an outer layer, a thermoplastic resin as an inner layer, and an adhesive resin layer disposed between the outer and inner layers. However, such laminated films do not use heat-generating particles and/or heat-shrinkable resins. In fact, such laminated films are noted to have high peeling or exfoliating resistance even at high temperatures.

### SUMMARY

In one aspect, a laminated composition is provided which includes a heat-shrinkable resin. In one embodiment, the laminated composition includes a first polymer layer having a first surface and a second surface; a second polymer layer having a first surface and a second surface; and an adhesive layer joining the second surface of the first polymer layer to the first surface of the second polymer layer; wherein the adhesive layer includes the heat-shrinkable resin including heat-generating particles.

In some embodiments, the heat-generating particles generate heat in response to exposure to electromagnetic radiation. In some embodiments, the electromagnetic radiation includes radiation of a wavelength in the near-, mid-, or far-infrared region of the spectrum. In some embodiments, the heat-generating particles include nanoshells. In some embodiments, the nanoshells include a non-conductive inner core coated with a layer of conductive material. In certain embodiments, the conductive material includes a metal selected from silver, gold, nickel, copper, iron, platinum, palladium, an alloy thereof, or a mixture of any two or more thereof. In some embodiments, the non-conductive core includes silicon dioxide, titanium dioxide, polymethyl methacrylate, polystyrene, gold sulfide, cadmium selenium, cadmium sulfide, gallium arsenide, or dendrimers.

In some embodiments, the first polymer layer and the second polymer layer are not the same polymer, polymer blend, or co-polymer. In other embodiments, the first and second polymer layers include a polyolefin, a polyester, a polyurethane, a polycarbonate, a polyphenylene, a polyacrylates, a blend of any two or more such polymers, or a co-polymer thereof. In some other embodiments, the first and second polymers include polyethylene, polypropylene, polyterephthalate, polystyrene, polymethylstyrene, polyvinylchloride, polymethylmethacrylate, a blend of any two or more such polymers, or a co-polymer thereof. In other embodiments, the first polymer layer includes polyvinylchloride, and the second polymer layer includes a polymer other than polyvinylchloride. In some embodiments, the first polymer layer includes polyvinylchloride, and the second polymer layer includes polyethylene, polystyrene, polyethyleneterephthalate, a polycarbonate, a polyacrylate, a blend of any two or more such polymers, or co-polymer thereof.

In some embodiments, the adhesive layer includes a hydrogel, a polycarbonate, a polyacrylate, a polymethylmethacrylate, a polyurethane, a polyolefin, a polyamide, a polytetrafluoroethylene, a polyetherimide, a polyvinyl chloride, a polyester, a polyphenylene, a sulfide, an ethylene-vinyl acetate copolymer, a blend of any two or more thereof, or a co-polymer thereof.

In another aspect, a method is provided for recycling a laminated composition. In some embodiments, the method includes exposing the laminated composition to electromagnetic radiation; and separating the first polymer layer from the second polymer layer. In some embodiments, the electromagnetic radiation includes radiation of a wavelength from 15 μm to 1000 μm.

In some embodiments, the laminated composition is cut, crushed, or shredded into small fragments prior to exposing the laminated composition to the electromagnetic radiation.

In some embodiments, the method also includes agitating the laminated composition during the exposing. The agitating causes the first polymer, the second polymer, or both the first polymer and the second polymer to become electrically charged. In some embodiments, the step of exposing the laminated composition to electromagnetic radiation includes inducing the heat-generating particles to heat and shrink the heat-shrinkable resin.

In some embodiments, the separating includes using an electrostatic separating device.

In yet another aspect, a method is provided for preparing a laminated composition. In some embodiments, such method includes applying an adhesive to the first surface of the first polymer layer; and binding the second surface of the second polymer layer to the adhesive; wherein the adhesive layer includes a heat-shrinkable resin comprising heat-generating particles.

In still another aspect, the technology provides an adhesive which includes a resin configured to shrink in response to heat and one or more particles configured to generate heat. In some embodiments, the particles configured to generate heat include nanoshells. In other embodiments, the nanoshells includes a non-conductive inner core coated with a layer of conductive material. In some embodiments, the conducting material includes a metal that is silver, gold, nickel, copper, iron, platinum, palladium, an alloy thereof, or a mixture of any two or more thereof. In some embodiments, the non-conductive core includes silicon dioxide, titanium dioxide, polymethyl methacrylate, polystyrene, gold sulfide, cadmium selenium, cadmium sulfide, gallium arsenide, or a dendrimer.

In some embodiments, the resin configured to shrink in response to heat or the heat shrinkable resin is selected from the group consisting of polyester resins, polystyrene resins, polyolefins, polyamide resins, acrylic polymers, polyvinyl chloride, polyvinyl acetate, and copolymers and blends thereof. In the adhesive further comprising a hydrogel, a polycarbonate, a polyacrylate, a polymethylmethacrylate, a polyurethane, a polyolefin, a polyamide, a polytetrafluoroethylene, a polyetherimide, a polyvinyl chloride, a polyester, a polyphenylene, a sulfide, an ethylene-vinyl acetate copolymer, a blend of any two or more thereof, or a co-polymer thereof. In one embodiment, the adhesive is used in a recyclable laminated composition.

### BRIEF DESCRIPTION OF THE DRAWINGS

FIG. 1 is an illustration of a laminated composition including a heat-shrinkable resin, according to one embodiment.

FIG. 2 is an illustration of the method for recycling a laminated composition that includes a heat-shrinkable resin, according to one embodiment.

### DETAILED DESCRIPTION

The illustrative embodiments described in the detailed description and claims are not meant to be limiting. Other embodiments may be utilized, and other changes may be made, without departing from the spirit or scope of the subject matter presented here.

In one aspect, a laminated composition is provided in which two polymer layers, i.e. a first polymer layer and a second polymer layer, are joined by an adhesive that includes a resin configured to shrink in response to heat (e.g. heat-shrinkable resin). The heat-shrinkable resin in the adhesive is configured to be responsive to a heat or radiation source by shrinking and pulling away from at least a portion of the first polymer layer and/or the second polymer layer. As the heat shrinkable resin pulls away from one or both of the first and second polymer layers in the laminate, the two polymer layers may then be separated and individually processed in recycling or re-use operations.

The laminated composition may find use in many applications including, but not limited to, packaging and covering materials such as films, sheets and bottles; in electrical components; in building and decorating materials such as wallpapers, kitchen countertops and laminated flooring; in automobile components such as body moldings, plastic engine parts, seats, windows, interior plastics, and the like; in electronic home appliances such as TV, transistors, and the like; and protective, tamper-proof coverings for identification cards such as security cards, bank cards, credit cards, identity cards and the like. The laminated compositions have improved recycling properties in comparison to similar laminates that do not include the heat-shrinkable resins as an adhesive.

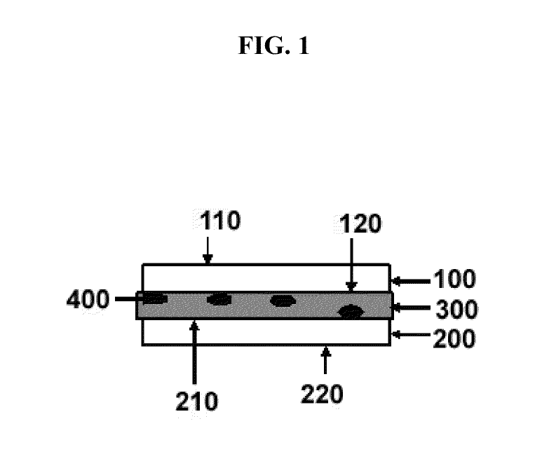

In one aspect, a laminated composition is provided including a heart-shrinkable resin. As illustrated in FIG. 1, the laminated composition may include a first polymer layer 100 having a first surface 110 and a second surface 120; a second polymer layer 200 having a first surface 210 and a second surface 220. Also included in the laminated composition, is an adhesive 300 that includes particles configured to generate heat 400. As illustrated in FIG. 1, the adhesive joins the second surface 120 of the first polymer layer 100 and the first surface 210 of the second polymer 200.

In various embodiments, the laminated composition may include layers in addition to the first and second polymer layers, which are bound to one another by their own corresponding adhesives including heat-shrinkable resins. For example, where the laminated composition includes three layers, a second surface of a first polymer layer is bound to a first surface of a second polymer layer by an adhesive, and the second surface of the second polymer layer is bound to the first surface of a third polymer layer by an adhesive. Such an example is merely illustrative of laminated compositions having more than two polymer layers.

The polymeric layers e.g. the first polymer layer and second polymer layer may include any known polymer material or combination of polymer materials compatible with the adhesive material containing the heat-shrinkable resin. According to some embodiments, the polymer layers, such as the first polymer layer and the second polymer layer are of the same polymeric composition. In other embodiments, the polymer layers are different polymeric material. As used herein the term “different polymeric materials” includes those polymers that have a different chemical composition; those polymer blends where the chemical composition may be the same but the ratios of the different polymers in the blends are different; and those co-polymers that have the same monomeric compositions in different ratios between the different layers. As used herein, where the term co-polymer thereof is used in a listing of polymers, it refers to co-polymers prepared from the monomers of the individually listed polymers.

In some embodiments, the first polymer layer and the second polymer layer are not the same polymer, polymer blend, or co-polymer. In other embodiments, the first polymer layer, the second polymer layer, and any additional polymer layers, include a polyolefin, a polyester, a polyurethane, a polycarbonate, a polyphenylene, a polyacrylate, a blend of any two or more such polymers, or a co-polymer thereof. In further embodiments, the first polymer layer and the second polymer layer include at least one polymer that is polyethylene, polypropylene, polyterephthalate, polystyrene, polymethylstyrene, polyvinylchloride, polymethylmethacrylate, a blend of any two or more such polymers, a co-polymer thereof, or other polymers, blends, or co-polymers as may be known to persons of skill in the art.

In some embodiments, the first polymer layer includes polyvinylchloride. In some such embodiments, the second polymer layer includes a polymer other than polyvinylchloride. For example, where the first polymer layer is polyvinylchloride, the second polymer may be polyethylene, polystyrene, polyethyleneterephthalate, a polycarbonate, a polyacrylate, a blend of any two or more such polymers, or a co-polymer thereof.

In some embodiments, the first polymer layer and the second polymer layer may be joined together by an adhesive layer. In some embodiments, the adhesive layer may include a polyester resin. In some embodiments the polyester resin may include a mixture of two or more types of polyester resin such as a copolymerized polyester resin derived from e.g., a dicarboxylic component and a diol component, a poly lactic acid resin (PLA resin) obtained by polymerization of hydroxyl carboxylic acid, and the like. In some embodiments, the dicarboxylic component may include an aromatic dicarboxylic acid such as terephthalic acid, isophthalic acid, 2-methyl terephthalic acid, 4,4-stilbene carboxylic acid, 4,4-biphenyl dicarboxylic acid, orthophthalic acid, 2,6-naphthalenedicarboxylic acid, 2,7-naphthalenedicarboxylic acid, bis-benzoic acid, bis(p-carboxylicphenyl)methane, anthracenedicarboxylic acid, 4,4-diphenyletherdicarboxylic acid, 4,4-diphenoxyethane dicarboxylic acid, 5-sodium sulfoisophthalic acid, and ethylene-bis-p-benzoic acid, an aliphatic dicarboxylic acid such as aromatic dicarboxylic acid, glutaric acid, adipic acid, suberic acid, sebacic acid, azelaic acid, dodecanedioic acid, 1,3-cyclohexanedicarboxylic acid, and 1,4-cyclohexanedicarboxylic acid. In some embodiments, the diol component may include diethylene glycol, triethylene glycol, polyethylene glycol, ethylene glycol, 1,2-propyleneglycol, 1,3-propanediol, 2,2-dimethyl-1,3-propanediol, trans-tetramethyl-1,3-cyclobutanediol, 2,2,4,4-tetramethyl-1,3-cyclobutanediol, 1,4-butanediol, neopentyl glycol, 1,5-pentanediol, 1,6-hexanediol, 1,4-cyclohexanedimethanol, 1,3-cyclohexanedimethanol, decamethylene glycol, cyclohexanediol, p-xylenediol, bisphenol-A, tetrabromobisphenol-A, tetrabromobisphenol-A-bis(2-hydroxyethyl ether). In some embodiments, the adhesive layer may include an acrylic resin. In an illustrative embodiment, the acrylic resin may be acryl urethane.

In some embodiments, the laminated composition may also include a primer coating layer between the first and/or second layer and the adhesive layer. This primer layer may be used to improve adhesiveness of the first and/or second layer to the adhesive layer. Thus, in some embodiments, the primer coating layer may include a resin composite including at least one thermoplastic resin as a main component. Various types of thermoplastic resin may be used for the primer coating layer as long as it adheres to the resins in the adhesive layer. In illustrative embodiments, the primer coating layer may include polystyrene resin, polyolefin resin, polyamide resin, polyester resin, polycarbonate resin, acrylic resin, ABS (acrylonitrile butadiene styrene resin), PPS (Polyphenylene sulfide resin) and the like.

In another aspect, the laminated composition is a metal support laminated with a polymer coating and the metal and polymer are bonded with an adhesive having particles configured to generate heat (e.g. heat generating particles). For example, the polymer may be a material such as a polystyrene resin, polyolefin resin, polyamide resin, polyester resin, polycarbonate resin, acrylic resin, ABS, PPS, polyethylene, polypropylene, polyterephthalate, polystyrene, polymethylstyrene, polyvinylchloride, polymethylmethacrylate and the like. The metal may be any of steel, stainless steel, magnesium, aluminum, titanium, zinc, and like structurally rigid metals. In yet another aspect, the laminated composition may include any other suitable material such as wood, veneers, paper, fabrics, glass, and asbestos.

In still another aspect, the technology provides an adhesive for use in the laminated composition. In some embodiments, the laminated composition can be readily recycled. In some embodiments, the adhesive includes a resin configured to shrink in response to heat and one or more particles configured to generate heat.

In certain embodiments, the adhesive includes a resin configured to shrink in response to heat (e.g. heat-shrinkable resin). Such resins shrink in shape and size when exposed to heat. In some embodiments, the heat-shrinkable resin may be included in the adhesive layer. Any suitable resin which can be configured to shrink in response to heat may be used in the present technology. In some embodiments the heat-shrinkable resins include polyester resins, polystyrene resins, polyolefins, polyamide resins, acrylic polymers, polyvinyl chloride, polyvinyl acetate, and copolymers and blends thereof. Suitable polyolefins include, e.g. polyethylene, such as high density polyethylene, medium density polyethylene, low density polyethylene and linear low density polyethylene; polypropylene, such as isotactic polypropylene, syndiotactic polypropylene, and copolymers and blends thereof. Suitable copolymers include random, alternating and block copolymers prepared from two or more different unsaturated olefin monomers, such as ethylene/propylene copolymers, butene/propylene copolymers, ethylene vinyl acetate and ethylene vinyl alcohol. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include poly(ethylene terephthalate), poly(butylene terephthalate), poly(tetramethylene terephthalate), poly(cyclohexylene-1,4-dimethylene terephthalate), and isophthalate copolymers thereof, as well as blends thereof. Suitable acrylic polymers include ethylene methyl methacrylate, urethane (meth)acrylate, and the like. In some embodiments, the adhesive layer may include a cyclic vinyl copolymer. In other embodiments, the heat-shrinkable adhesive layer may include a styrene foamed film characterized by having at least one foamed layer which contains a resin composition which includes from 20 to 100 parts by mass of the following (a) and from 0 to 80 parts by mass of the following (b) and which has a thickness of from 30 to 200 Pm and a specific gravity of from 0.3 to 0.9:

(a) a block copolymer wherein the ratio of a vinyl aromatic hydrocarbon to a conjugated diene is from 50/50 to 90/10,
(b) at least one vinyl aromatic hydrocarbon polymer selected from the following (i) to (v):
(i) a block copolymer of a vinyl aromatic hydrocarbon with a conjugated diene, (ii) a vinyl aromatic hydrocarbon polymer, (iii) a copolymer of a vinyl aromatic hydrocarbon with (meth)acrylic acid, (iv) a copolymer of a vinyl aromatic hydrocarbon with a (meth)acrylate, and
(v) a rubber-modified styrene polymer.

In additional to the heat-shrinkable resin, the adhesive layer may also include an adhesive which will bind a first polymer layer to a second polymer layer. Such adhesives include, but are not limited to a hydrogel, a polycarbonate, a polyacrylate, a polymethylmethacrylate, a polyurethane, a polyolefin, a polyamide, a polytetrafluoroethylene, a polyetherimide, a polyvinyl chloride, a polyester, a polyphenylene, a sulfide, an ethylene-vinyl acetate co-polymer, a blend of any two or more such polymers, or a co-polymer thereof. In some embodiments, the adhesive layer includes one or more polyacrylamides and a hydrogel.

The adhesive layer which includes heat-shrinkable resin may be designed in such a way that under normal conditions it strongly holds the polymer layers together. However, when exposed to a suitable stimulus, such as a heat or radiation source, the resins and hence the adhesive layer shrinks and pulls away thus leading to the separation of the polymer layers.

The stimulus required to shrink the resin in the adhesive may be provided by suitable methods known in the art. In some embodiments, heat-generating particles may be used for this purpose. Thus, in some embodiments, the adhesive layer and/or the heat shrinkable resin may include particles configured to generate heat (heat generating particles). These heat-generating particles are made of suitable heat generating materials. These materials are capable for converting any other form of energy, such as chemical and electrical and mechanical and magnetic energy, in to heat energy or thermal energy. These materials are also capable of propagating or transmitting heat energy from one heat generating particle to another. Thus, in one embodiment, the heat-generating materials generate or propagate heat in response to different stimuli such as a magnetic field, lasers, electromagnetic radiation, heat, solar power, electricity, light, and the like. According to one embodiment, the heat-generating particles generate heat in response to exposure to electromagnetic radiation.

The nanoshells may be configured to generate heat by exposure to electromagnetic radiation of a suitable wavelength. In some embodiments, the electromagnetic radiation includes radiation of a wavelength in the near-, mid-, or far-infrared region of the spectrum. In some embodiments, the electromagnetic radiation includes radiation of a wavelength from 0.75 μm to 1000 μm. In other embodiments, the electromagnetic radiation includes near-infrared radiation having a wavelength from 0.75 μm to 2.5 μm. In another embodiment, the electromagnetic radiation includes mid-infrared radiation having a wavelength from 2.5 μm to 10 μm. In yet another embodiment, the electromagnetic radiation includes far-infrared radiation having a wavelength from 10 μm to 1000 μm. In some embodiments, the electromagnetic radiation includes radiation of a wavelength from 15 μm to 1000 μm. According to some embodiments, the heat generating particles have a wavelength absorbance maxima in the range of approximately 400 nm to 20 μm.

The heat-generating particles may be composed of materials capable of generating heat in response to a stimulus. As explained above, these materials are capable for converting other forms of energy in to heat energy or thermal energy or even transport or conduct heat energy. Such materials include, but are not limited to heat conductive materials, or non-conductive materials that may be coated with heat-conductive materials. For example, the material may be carbon-based heat-generating materials, silicon-carbide based heat-generating materials or metal based heat-generating materials. In some embodiments, the heat-generating particles include nanoshells.

A nanoshell is typically defined as a type of spherical nanoparticle consisting of a dielectric core which is covered by a thin metallic shell. In some embodiments, the nanoshells include a non-conducting inner core coated with a layer of conducting material. In certain embodiments, the conducting material is a metal such as, but not limited to, silver, gold, nickel, copper, iron, platinum, palladium, an alloy of such metals, or a mixture of any two or more such metals. Such metal nanoshells are a class of nanoshells with tunable resonance to electromagnetic radiation. Nanoshells possess a highly tunable plasmon resonance, whereby light of particular frequencies causes collective oscillations of conductive metal electrons at the nanoshell surface, thus greatly concentrating the intensity of the light. The plasmon resonance of nanoshells can readily be tuned to a wide range of specific frequencies, from the near ultra violet to the mid-infra-red, simply by controlling the relative thickness of the core and shell layers of the nanoparticle. In some embodiments, the core layer may be non-conducting or dielectric. Suitable dielectric core materials include, but are not limited to, silicon dioxide, gold sulfide, titanium dioxide, polymethyl methacrylate (PMMA), polystyrene, and macromolecules such as dendrimers. The material of the nonconducting layer influences the properties of the particle, so the dielectric constant of the core material affects the absorbance characteristics of the particle. The core may be a mixed or layered combination of dielectric materials. Thus, in some embodiments, the non-conducting core includes silicon dioxide, titanium dioxide, polymethyl methacrylate, polystyrene, gold sulfide, cadmium selenium, cadmium sulfide, gallium arsenide, or dendrimers. The shell layer may coat the outer surface of the core uniformly, or it may partially coat the core with atomic or molecular clusters.

In some embodiments, the heat-generating particles may include a gold sulfide core and a gold shell. In other embodiments, the core may be composed of silicon dioxide and the shell may be composed of gold. In yet other embodiments, the heat-generating particles may include optically tuned nanoshells embedded within a polymer matrix. The term “optically tuned nanoshell” means that the nanoshell has been fabricated in such a way that it has a predetermined or defined shell thickness, a defined core thickness and core radius:shell thickness ratio, and that the wavelength at which the particle significantly, or preferably substantially maximally absorbs or scatters light is a desired, preselected value. Accordingly, such optically tuned nanoshells can be configured so that they scatter or absorb light from a specific region of the spectrum. In some such embodiments, the nanoshells may be embedded in the surface of a N isopropylacrylamide and acrylamide hydrogel. In some embodiments, the nanoshells and polymer may together form microparticles, nanoparticles, or vesicles. In some embodiment, various dielectric materials such as ceramic, mica, and plastics may be used as the core.

In some embodiments, the heat-generating particles employed in the present examples are two-layered, having a non-conducting core and a conducting outer layer or shell. In some embodiments, an optically tuned multi-walled or multi-layer nanoshell particle may be formed by alternating non-conducting and conducting layers. While, it is desirable that at least one shell layer readily conduct electricity, however, in some cases it may only be necessary that one shell layer have a lower dielectric constant than the adjacent core layer. This is because, if the dielectric constant of the adjacent shell layer is greater than the core layer, than the absorbance maximum will be blue-shifted (hypsochromic shift) causing a shift of absorption position to lower wavelength region, thus affecting the heat conducting properties of the nanoshell.

The core may have a spherical, cubical, cylindrical or other shape. Regardless of the geometry of the core, it is preferred that the particles be substantially homogeneous in size and shape, and preferably spherical. In certain embodiments, wherein the compositions may include a plurality of metal nanoshells, such compositions may include particles of substantially uniform diameter ranging up to several microns, depending upon the desired absorbance properties of the particles. Larger diameter particles will absorb over a wider range of wavelengths than smaller diameter particles.

The diameter of the heat-generating particles may depend on the thickness of the adhesive layer, or vice versa. In some embodiments, the particles may have a homogeneous radius that can range from 1 nanometer to several microns, depending upon the desired absorbance maximum of the embodiment. In some embodiments, the diameter could be 1/10 of the thickness of the adhesive layer. In an illustrative embodiment, the particle core may be between 1 nm up to 5 μm in diameter, the shell may be 1-100 nm thick, and the particle may have an absorbance maximum wavelength of 300 nm to 20 μm, in the near-infrared range. Heat-generating particles may be constructed with a core radius to shell thickness ratio ranging from 2-1000. This large ratio range, coupled with control over the core size, results in a particle that has a large, frequency-agile absorbance over most of the visible and infrared regions of the spectrum. Thus, in some embodiments, the heat-generating particles may be provided having a range of core radius to shell thickness ratios.

The laminate composition may find several uses as stated above and can be used in a wide variety of applications. Prior to recycling, if the laminated composition is required to be exposed to heat, e.g. during fabrication or molding processes, then the adhesive layer should be coated with a highly heat insulating material prior to adding the heat-generating particles to the heat-shrinkable resin. Thus, in one embodiment, the adhesive layer may further include an outer coating layer which includes a heat-insulating material to minimize or avoid heat-shrinking of the adhesive layer during the exposure to heat prior to recycling. The heat-insulating layer can be any suitable layer that has heat-insulative activity. Examples of such heat-insulating layers include e.g., a non-foamable layer comprising hollow particles. The hollow particles can be any suitable hollow particles, such as e.g., those including any of acrylic polymers and vinylidene chloride polymers.

In another aspect, a method is provided for recycling the laminated composition. In general, the method includes generating heat in the heat-shrinkable resin by exposing the laminated composition to a stimulus to activate the heat-generating particles in the resin. For example, the stimulus may include, but is not limited to, a magnetic field, lasers, electromagnetic radiation, heat, solar power, electricity, light, and the like. In some embodiments, the method includes exposing the laminated composition to electromagnetic radiation; and separating the first polymer layer from the second polymer layer.

To facilitate separation of the laminate composition, it may be more convenient to handle small fragments of laminate composition. Therefore, in some embodiments, the laminated composition is cut, crushed, or shredded into small fragments prior to exposing the laminated composition to the stimulus.

Where electromagnetic radiation is the stimulus applied to the heat-shrinkable adhesive resin, the laminated composition may be exposed to electromagnetic radiation having a suitable wavelength. In some embodiments, the electromagnetic radiation includes radiation of a wavelength in the near-, mid-, or far-infrared region of the spectrum. In some embodiments, the electromagnetic radiation includes radiation of a wavelength from 0.75 μm to 1000 μm. In other embodiments, the electromagnetic radiation includes near-infrared radiation having a wavelength from 0.75 μm to 2.5 μm. In another embodiment, the electromagnetic radiation includes mid-infrared radiation having a wavelength from 2.5 μm to 10 μm. In yet another embodiment, the electromagnetic radiation includes far-infrared radiation having a wavelength from 10 μm to 1000 μm. In some embodiments, the electromagnetic radiation includes radiation of a wavelength from 15 μm to 1000 μm. In some embodiments, the laminated composition is crushed and prior to exposure to far-infrared radiation.

While not wishing to be bound by theory, it is believed that the high-heat-generating particles in the resin generate heat and the adhesive layer shrinks, causing the adhesive layer to shift and for polymer layers adjacent to the adhesive layer to disengage from the adhesive layer. This results in de-lamination of the laminated composition. Thus, in some embodiments, the step of exposing the laminated composition to electromagnetic radiation also includes inducing the heat-generating particles to heat and to shrink the heat-shrinkable resin. The laminated material can be selectively separated by heating the adhesive resin in only specific areas where it is intended to separate the layers.

In some embodiments, the method includes agitating the laminated composition during the exposing. The agitation may cause some or all of the various polymer layers and different types of resins, having distinctive properties, to be electrically charged through contact with one another due to an effect referred to as a “turboelectric effect.” Thus, the agitation may cause the first polymer, the second polymer, or both the first polymer and the second polymer to become electrically charged. This turboelectric effect can be effectively used to separate various layers in the laminate composition.

Without being bound by theory, the surfaces of polymer materials are easily electrically charged, and if the electrical charge is not discharged, static electricity can accumulate on the polymers as they repeatedly come in contact with one another, regardless of whether they are conductors or insulators. It is also believe that agitating the different types of resins with different properties, after applying a heat generating stimulus, causes differences in surface temperatures, in turn causing different charged states

Once electrically charged, the different polymer layers may then be separated using a suitable electrostatic separation method. Thus, in some embodiments, the separating includes employing an electrostatic separating device. One such electrostatic separating device is described in U.S. Pat. Nos. 6,903,294 and 6,522,149, which are incorporated herein by reference. Such electrostatic separators are also commercially available e.g., Hyper Cycle Systems (HCS) from Mitsubishi electrics, the electrostatic separator from Tyrone environmental group or from Bunting Magnetics Co.

In one embodiment, the separation includes exposing the charged components of the de-laminated laminate composition to an electrostatic device. The electrostatic device may include electrostatic fields of opposite polarities whereby the various charged polymers migrate toward the respectively oppositely charged field causing them to separate. The separated fragments can then be collected and reused. The method may be used to facilitate de-lamination of the laminate composition and separate the individual components, thereby facilitating recycling of the polymers layers of the laminate composition.

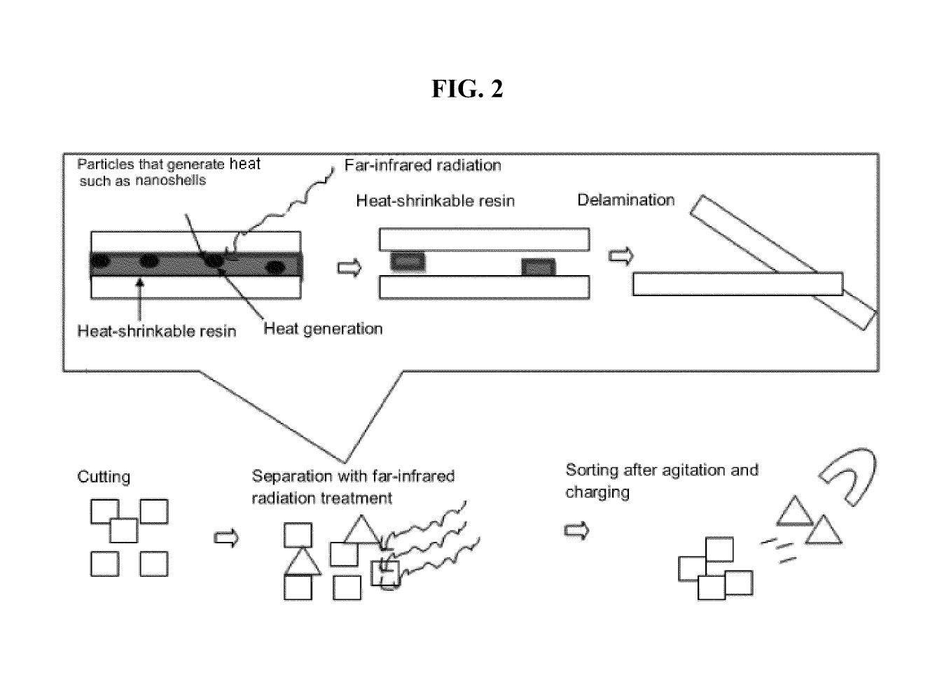

FIG. 2 is an illustration of the recycling of a laminated composition according to one embodiment. As shown in the illustration, as an example, far-infrared radiation impinges on the laminated composition which includes the heat-shrinkable resin and heat-generating particles. As the heat is generated the polymer layers shift and separate resulting in de-lamination of the laminated composition. Prior to the introduction of the far-infrared radiation, the laminated composition is reduced to fragments that will be more amenable to such heat-generating treatment. After de-lamination, the particles may then be electrically charged and sorted to separate the polymer layers of various compositions.

In another aspect, a method is provided for preparing the laminated composition. In some embodiments, the method includes applying an adhesive to a second surface of a first polymer layer; and binding the first surface of the second polymer layer to the adhesive. The adhesive in such laminated compositions includes a heat-shrinkable resin. The adhesives and/or the resin include heat-generating particles. Such methods may also include pressing the first polymer layer, the second polymer layer, and the adhesive layer after binding together to ensure a complete binding of the layers.

In other embodiments, the method may include binding multiple polymer layers. In such embodiments, each layer is bound to the other as described above using an adhesive which includes a heat-shrinkable resin.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present technology, thus generally described, will be understood more readily by reference to the following examples, which are provided by way of illustration and are not intended to be limiting in any way.

### EXAMPLES

The present technology is further illustrated by the following examples, which should not be construed as limiting in any way.

### Example 1

A recycleable cell phone housing. A cell phone housing may include an underlayer (i.e. first polymer layer) is an acrylonitrile-butadiene-styrene (ABS); a overlay polymer, (i.e. second polymer layer) is polymethylmethacrylate (PMMA); and a primer/adhesive layer between the first and second polymer layers is an acryl urethane. The ABS as an underlayer, is formed by injection molding and having a thickness of approximately 0.8 mm. An acryl urethane may be used as the primer/adhesive is coated on the underlayer in a thickness from 50 μm to 100 μm, and the acryl urethane is to contain heat-generating particles. The PMMA as top coat is sprayed on the primer/adhesive. The composition is to then be hardened by ultraviolet light activation so that a top coat layer of a thickness of 100 μm to 200 μm is formed.

Thus, this configuration will enable recycling of the housing by ungluing of the top layer from the bottom layer by deformation of the adhesive layer, when the adhesive layer shrinks with heat.

### Example 2

A recycleable computer frame. A computer frame may include a composite main frame and a sub-frame. The sub-frame is metal that provides a support for the molded main frame, which is made of a molded polymer. Examples of polymers that may be used include polybutylene terephthalate (PBT), polystyrene (PS), ABS, polypropylene (PP), and polycarbonate. The metal for the sub-frame may be made of steel, stainless steel, magnesium, aluminum, titanium, zinc, and like structurally rigid metals. Where the main frame is molded around, or place around, the sub-frame, a heat-shrinkable adhesive may be used to join the two frames. For example, an acryl urethane containing heat-generating particles may be used as the heat-shrinkable adhesive and may be coated on the sub-frame in a thickness from 50 μm to 100 μm. When the frame is then recycled, it is irradiated with infra-red radiation from a Nd:YAG laser (1064 nm, 300 mJ) for a sufficient time period (i.e. about 5 minutes) to shrink the adhesive and allow the polymer main frame to separate from the metal sub-frame. The polymer and metal components may then be separately recycled.

### EQUIVALENTS

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

Other embodiments are set forth in the following claims.

1. An adhesive comprising a resin configured to shrink in response to heat and one or more particles configured to generate heat.

2. The adhesive of claim 1, wherein the particles configured to generate heat comprise nanoshells.

3. The adhesive of claim 2, wherein the nanoshells comprise a non-conductive inner core coated with a layer of conductive material.

4. The adhesive of claim 3, wherein the conducting material comprises a metal that is silver, gold, nickel, copper, iron, platinum, palladium, an alloy thereof, or a mixture of any two or more thereof.

5. The adhesive of claim 3, wherein the non-conductive core comprises silicon dioxide, titanium dioxide, polymethyl methacrylate, polystyrene, gold sulfide, cadmium selenium, cadmium sulfide, gallium arsenide, or a dendrimer.

6. The adhesive of claim 1, wherein the heat shrinkable resin is selected from the group consisting of polyester resins, polystyrene resins, polyolefins, polyamide resins, acrylic polymers, polyvinyl chloride, polyvinyl acetate, and copolymers and blends thereof.

7. (canceled)

8. A laminated composition comprising:
a first polymer layer having a first surface and a second surface;
a second polymer layer having a first surface and a second surface; and
an adhesive layer joining the second surface of the first polymer to the first surface of the second polymer layer, the adhesive layer comprising a resin configured to shrink in response to heat and one or more particles configured to generate heat.

9. The laminated composition of claim 8, wherein the one or more particles are configured to generate heat in response to exposure to electromagnetic radiation.

10. The laminated composition of claim 9, wherein the electromagnetic radiation comprises radiation of a wavelength in the near-, mid-, or far-infrared region of the electromagnetic spectrum.

11. The laminated composition of claim 8, wherein the particles configured to generate heat comprise nanoshells.

12. The laminated composition of claim 11, wherein the nanoshells comprise a non-conductive inner core coated with a layer of conductive material.

13. The laminated composition of claim 12, wherein the conductive material comprises a metal that is silver, gold, nickel, copper, iron, platinum, palladium, an alloy thereof, or a mixture of any two or more thereof.

14. The laminated composition of claim 12, wherein the non-conductive inner core comprises silicon dioxide, titanium dioxide, polymethyl methacrylate, polystyrene, gold sulfide, cadmium selenium, cadmium sulfide, gallium arsenide, or a dendrimer.

15. (canceled)

16. The laminated composition of claim 8, wherein the first polymer layer and the second polymer layer are not the same polymer, polymer blend, or co-polymer and wherein the first polymer layer comprises a polyolefin, a polyester, a polyurethane, a polycarbonate, a polyphenylene, a polyacrylate, a blend of any two or more thereof, or a co-polymer thereof; and the second polymer layer comprise a polyolefin, a polyester, a polyurethane, a polycarbonate, a polyphenylene, a polyacrylate, a blend of any two or more thereof, or a co-polymer thereof.

17. The laminated composition of claim 8, wherein the first polymer layer comprises polyvinylchloride; and the second polymer layer comprises a polymer other than polyvinylchloride.

18. (canceled)

19. The laminated composition of claim 8, wherein the adhesive layer comprises a hydrogel, a polycarbonate, a polyacrylate, a polymethylmethacrylate, a polyurethane, a polyolefin, a polyamide, a polytetrafluoroethylene, a polyetherimide, a polyvinyl chloride, a polyester, a polyphenylene, a sulfide, an ethylene-vinyl acetate copolymer, a blend of any two or more thereof, or a co-polymer thereof.

20. A method comprising:
exposing a laminated composition to an electromagnetic radiation, the laminated composition comprising:
a first polymer layer having a first surface and a second surface;
a second polymer layer having a first surface and a second surface; and
an adhesive layer joining the second surface of the first polymer layer to a first surface of the second polymer layer, the adhesive layer comprising a heat-shrinkable resin comprising heat-generating particles; and
separating the first polymer layer from the second polymer layer.

21. The method of claim 20, wherein the electromagnetic radiation comprises radiation of a wavelength from 15 μm to 1000 μm.

22-24. (canceled)

25. The method of claim 20, wherein the separating comprises using an electrostatic separating device.

26. The method of claim 20, wherein the exposing the laminated composition to electromagnetic radiation comprises inducing the heat-generating particles to heat and shrink the heat-shrinkable resin.

27. (canceled)
